(19) United States
(12) Patent Application Publication
(10) Pub. No.: US 2010/0109451 A1
(43) Pub. Date: May 6, 2010

(54) ENERGY ACCUMULATOR COMPRISING A SWITCHED RELUCTANCE MACHINE

(75) Inventors: Andreas Grundl, Starnberg (DE); Bernhard Hoffmann, Starnberg (DE)

Correspondence Address: CARTER, DELUCA, FARRELL & SCHMIDT, LLP, 445 BROAD HOLLOW ROAD, SUITE 420, MELVILLE, NY, 11747, US

(73) Assignee: COMPACT DYNAMICS GMBH, Starnberg (DE)

(21) Appl. No.: 12/595,457

(22) PCT Filed: Apr. 8, 2008
(86) PCT No.: PCT/EP08/02783

§ 371 Date: Jan. 6, 2010

(30) Foreign Application Priority Data
Apr. 12, 2007 (DE) 10 2007 017 342.5

(51) Int. Cl. H02K 37/04; H02K 5/10

(52) U.S. Cl. 310/46; 310/89; 903/906

(57) ABSTRACT

The energy storage device has an electrical machine (12) comprising a rotor (14) and a stator (16), the stator (16) being separated from the rotor (14) by an air gap (18) and having at least one stator coil (20). The rotor (14), moreover, has a fly-mass (22) and, together with the latter, constitutes a rotating body. The rotor (14) or the rotating body consists of a multiplicity of thin sheet-metallic discs (30), which have the form, substantially, of an annular disc having an outer edge and an inner edge. There has been applied to these sheet-metal discs (30), at their outer edge, a first tensile stress and, at their inner edge, a first shear stress.

### INTRODUCTION

Described in the following is an energy storage device that is suitable, for example, for use in a land vehicle. This can be an energy storage device for vehicles that are equipped exclusively, or in addition to an internal combustion engine, with at least one electrical machine in the drive train. The described energy storage device is also suitable, however, for use in stationary or flying applications.

### BACKGROUND

In the past, the electrical energy required in motor vehicles was, practically, produced entirely from fossil fuel (petrol, natural gas or diesel). In the case of electrically operated rail vehicles there is, for example, the concept whereby the kinetic energy released during braking is changed back into electrical (potential) energy—instead of being converted into frictional heat—and is fed back into the supply network. Now also in motor vehicles, by means of appropriate feedback control devices, during braking phases at least a portion of the braking energy is to be converted into electrical energy, stored and reused. In travel situations in which braking energy is changed into electrical energy, the latter can be stored for subsequent situations for the purpose of supporting or replacing the drive energy from the internal combustion engine. In this way, approximately 5%-20% or more of the drive energy from the internal combustion engine can be replaced or be additionally available for short periods in a supporting manner (for example, for overtaking operations in road traffic). Since lead batteries are heavy and have only a limited energy density, there is increasingly a changeover to other types of energy storage device (so-termed double-layer capacitors, ultracaps, etc.). They are suitable for the short-period provision (<1 min.) of energy and for covering peak loads. At present, however, their energy density, also, is limited to approximately 4-6 Wh/kg.

### PRIOR ART

DE 24 54 753 A1 shows a fly-mass storage device having a rotor. The rotor is composed of radially extending planar discs of equal thickness that are above one another axially. The rotor has, for example, short-circuit conductors and is surrounded by a stator.

U.S. Pat. No. 3,368,424 shows a flywheel of laminated design, in which laminated plates are to be subjected to more uniform loading over their entire extent in order to render possible a more economic utilization of the material and a greater operational reliability.

This flywheel has two opposing sets of laminated plates. Each set is composed of annular discs, which are flat at their periphery, slightly conical on their main surface and more conically shaped at their central surface. The laminated plates are preloaded by the axial pressure applied to the more conically shaped surface of the outermost discs, in order to put the inwardly curved surfaces of the discs under shear stress and to put the flat, peripheral surfaces of the disc under tensile stress. In the case of high rotational speed, the centrifugal forces cause in the discs radial and tangential tensile-stress loads, which are at their least at the periphery, but which increase towards the centre of the disc surface, where the loading normally attains the critical maximum. However, the static preloading increases the stresses, resulting from centrifugal forces, in the peripheral surfaces, and reduces the greater tensile stresses in the central and inner surfaces of the discs.

The energy storage device described in the following can have a high energy density, and/or a long service life, can be constructed in a simple manner that is suitable for use in production vehicles, and/or can have a low fault susceptibility, combined with a high degree of energy recuperation.

### CONCISE SUMMARY

The energy storage device can have an electrical machine comprising a rotor and a stator, the stator being separated from the rotor by an air gap and having at least one stator coil. The rotor can be surrounded by the stator. As an alternative thereto, the rotor can also surround the stator. Moreover, the rotor can be assigned to a fly-mass and, together with the latter, constitute a rotating body. The rotor or the rotating body can be constituted by a multiplicity of thin sheet-metallic discs, which have the form, substantially, of an annular disc having an outer edge and an inner edge. These sheet-metal discs, at least in the motionless state, thus when the rotor is stationary, are subject to a first tensile stress at their outer edge and to a first shear stress at their inner edge. A thin, planar sheet-metal disc in this case is understood to mean that its thickness is between approximately 0.1% and approximately 5% of the outer diameter, any intermediate value between these two values also being deemed as disclosed here.

A possibility for subjecting the sheet-metal discs, in the motionless state, to a tensile stress at their outer edge and to a shear stress at their inner edge consists that in hollow sheet-metal parts, having the form of a curved surface of a truncated circular cone (and being mechanically substantially stress-free), are pressed into a (an at least almost) flat form. As a result, the outer edge of the thus produced sheet-metal discs is subjected to tensile stress and their inner edge is subjected to shear stress.

Another possibility is to join two planar, concentric rings to one another (for example, by welding or positive joining), the inner ring being under shear stress and the outer ring being under tensile stress. As a result, there is thus obtained a planar sheet-metal disc that, likewise, (in the non-rotating state), is subjected to a tensile stress at its outer edge and to a shear stress at its inner edge. Since two differing materials, for example metals, are also used in this case, there is the possibility, in the case of this variant, of selecting a greater strength for the inner ring and optimizing the outer ring in respect of its magnetic properties. The result of this is an electrical machine of overall greater efficiency.

Such an energy storage device has two operating modes: a generator operating mode and a motor operating mode. When the energy storage device is in the motor operating mode or the charging operating mode, the stator coils of the energy storage device are supplied with electric current, which comes from an electrical machine assigned to the drive train of the motor vehicle. This electrical machine is consequently in the generator operating mode and brakes the motor vehicle. As a result, the rotor and, with it, the fly-mass of the energy storage device, is put into rotation.

When the energy storage device is in the generator operating mode or the discharging operating mode, its rotor, with the fly-mass, rotates at a high rotational speed, as a result of which the stator coils of the energy storage device then supply electrical energy. This electrical energy is fed into the electrical machine present in the drive train of the motor vehicle. This electrical machine is consequently in the motor operating mode, and drives the motor vehicle.

The material strength of the sheet-metal discs of the rotor, or of the rotating body, in this case constitutes a factor limiting the rotational speed of the energy storage device. From the relationship Eₖᵢₙ=½·J·ω², wherein Eₖᵢₙ is the kinetic energy of the rotating body (rotor and fly-mass), and consequently of the energy storage device in joules, J is the mass moment of inertia in kgm², and ω is the angular velocity of the rotating body in s⁻¹, it ensues that a possible increase in the rotational speed (angular velocity) of the rotating body has the effect of squaring the energy to be stored in/taken from the body.

To subject the sheet-metal discs, in the motionless state, to a tensile stress at their outer edge and to a shear stress at their inner edge allows a higher rotational speed of the rotor than if—otherwise corresponding—sheet-metal discs lacking these properties were used instead.

These sheet-metal discs, obtained in one of the two ways described above (or in other ways), and joined to one another, i.e. stacked upon one another, to constitute the rotating body, can then be brought to a rotational speed at which, as a result of the centrifugal force acting upon them, they are subjected, at their outer edge, to a tensile stress that is greater than the first tensile stress, and are subjected, at their inner edge, to a shear stress that is less than the first shear stress. This rotational speed can be higher than would be the case in view of the strength properties of the material(s) of the sheet-metal discs without the tensile/shear stresses applied to them.

The energy storage device is suitable, for example, for a land vehicle having an electrical drive, for the purpose of storing energy released in the case of regenerative braking by means of at least one electrical machine in or on the drive train of the vehicle. In such an arrangement, the energy storage device is connected to the electrical machine in or on the drive train of the vehicle, the electrical power that is converted during braking of the vehicle being fed into the energy storage device. The electrical machine in the energy storage device is thereby put into rotation, together with the fly-mass assigned to the rotor. Possible rotational speeds in this case are between approximately 150,000 and 220,000 revolutions per minute, and more.

The energy recovered during braking need not necessarily be used to fully charge the energy storage device of the motor vehicle. Rather, a charge state of the energy storage device can be determined and adjusted, in dependence on relevant environmental conditions, for a standing consumption and the starting capability (e.g. in start-stop operation in urban traffic) of the vehicle. A more extensive charging of the energy storage device can therefore be effected in travel phases that are favourable in respect of energy (=recuperation phases), in which no fuel would be consumed for this purpose. If, in these recuperation phases, the energy storage device were to be charged beyond the starting capability/standing consumption charge, electrical energy is available that can be fed directly into the on-board power supply network without having to be provided by the (fuel-driven) generator. This surplus capacity can be used such that less energy, or no energy, is taken from the otherwise fuel-operated generator, which can result in a lesser fuel consumption of the motor vehicle.

By means of this energy storage device, optimum use can be made of the energy recuperation potential in the case of land vehicles, in the case of motor vehicles having hybrid drive, or in the case of motor vehicles having an adequately dimensioned starter generator assigned to the drive train. The electrical machines can recover as much energy as possible during braking of the motor vehicle. Braking requirements that go beyond regenerative braking can be covered by the friction brake.

The rotor of the energy storage device can constitute, at least together with at least one part of the fly-mass, a rotating body that has a substantially pot-shaped form, having a base part and a substantially annular-cylindrical wall part. The annular-cylindrical wall part in this case can have either a substantially round annular-cylindrical form or a polygonal annular form.

The electrical machine can be a switched reluctance machine, the rotor and stator of which are grooved. The rotor, or the rotating body, can be constituted by metal-sheet layers, for example thin metal-sheet layers containing iron-carbon, that are layered axially in relation to its rotational axis. Should a defect (e.g. of the rotor) occur that causes the rapidly rotating rotor to disintegrate, the thin metal-sheet layers would be able to cause only limited damage.

The rotor can be rotatably supported against the housing by means of, for example, a fluid bearing. Also possible, however, as a bearing arrangement for the rotor in relation to the housing, or the stator, are other bearing variants, for example radial roller bearings or rolling-contact bearings, ball bearings, ceramic bearings or the like.

Another energy storage device has a rotor that is rotatably mounted relative to the housing and relative to the rotor. The stator is therefore not a stationary assembly (relative to the housing). Rather, when current is supplied to the stator coil(s), the stator and the rotor rotate in opposing directions. Consequently, the mass of the stator (which has a greater rotational radius than the rotor) can also be used for the purpose of storing energy. This increases the power density of the overall arrangement of the energy storage device. Strictly speaking, in the case of this arrangement, one would no longer use the terms rotor and stator; in this case, there are actually two rotors, being an inner and an outer rotor, rotating in opposing directions.

Likewise, provision can also be made in this case whereby the two rotors (i.e. the “rotating stator” and the rotor) are constituted by thin sheet-metal discs having an outer edge and an inner edge. The thin sheet-metal discs of the “rotating stator” and of the rotor, when in the motionless state, i.e. when stationary, are subjected to a first tensile stress at their outer edge and to a first shear stress at their inner edge. This allows energy to be stored in a particularly space-efficient and weight-efficient manner.

When in the rotating state, the sheet-metal discs of the rotating stator are then also subjected, at their outer edge, to a tensile stress that is greater than the first tensile stress, and are subjected, at their inner edge, to a shear stress that is less than the first shear stress.

In this case, the at least one stator coil can be electrically contacted via a slipring arrangement.

Further features, characteristics, advantages and possible modifications of this energy storage device are elucidated on the basis of the following description, in which reference is made to the appended drawings.

### BRIEF DESCRIPTION OF THE FIGURES

FIG. 1 shows a schematic, lateral sectional representation of an energy storage device.

FIG. 2 shows a schematic, transverse sectional representation of the energy storage device.

FIGS. 3a, 3b show a schematic top view of a variant of a sheet-metal disc of the energy storage device.

FIG. 4 shows a schematic top view of a further variant of a sheet-metal disc of the energy storage device.

FIG. 5 shows a schematic stress diagram of a sheet-metal disc of the energy storage device.

FIG. 6 shows a schematic, lateral sectional representation of a rotor of the energy storage device.

FIG. 7 shows a schematic representation of a drive train of a motor vehicle having the energy storage device.

FIG. 8 shows a schematic, lateral sectional representation of a further energy storage device.

### DETAILED DESCRIPTION OF EMBODIMENT VARIANTS OF THE ENEMY STORAGE DEVICE

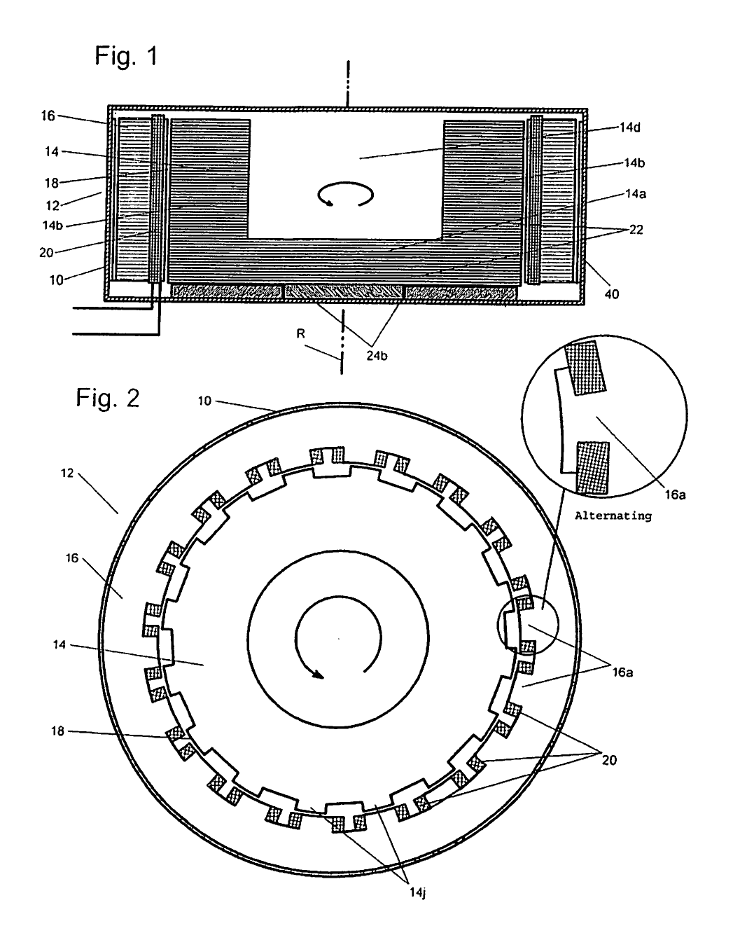

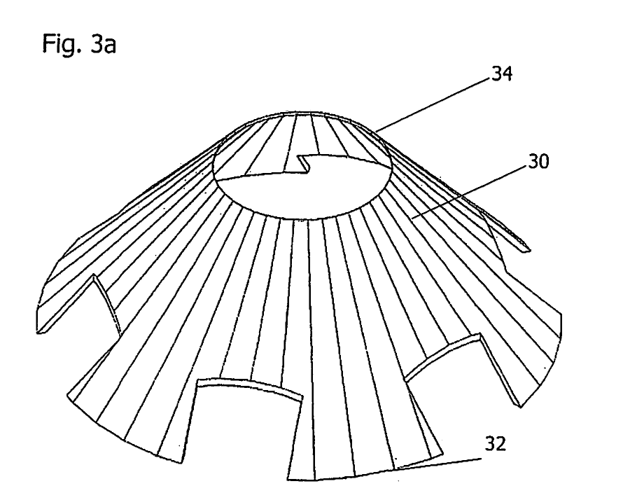

Shown in FIGS. 1 and 2 is an energy storage device that is arranged in a closed, circular-cylindrical, shear-resistant housing 10. Accommodated in the housing 10 is an electrical machine 12 in the form of a switched reluctance machine that comprises a rotor 14 and a stator 16. Details of the reluctance machine are explained further below. The stator 16 is separated from the rotor 14 by an air gap 18, and has a multiplicity of stator coils 20, which are assigned, respectively, to a stator tooth 16a. The rotor 14 is surrounded by the stator 16 and has a substantially pot-shaped form, having a base part 14a and a substantially annular-cylindrical wall part 14b. Further, assigned to the rotor 14 in a structurally integral manner is a fly-mass 22, which, together with the rotor 14, constitutes a rotating body. In the example shown, this fly-mass 22 is constituted in that the base part 14a and the annular-cylindrical wall part 14b are composed of significantly more material than would be necessary for the functioning of the electrical machine 12. In other words, the rotor 14 is designed to be ‘thicker’ (thus, having more material) both in the radial and in the axial direction than is indicated for electrical/magnetic reasons.

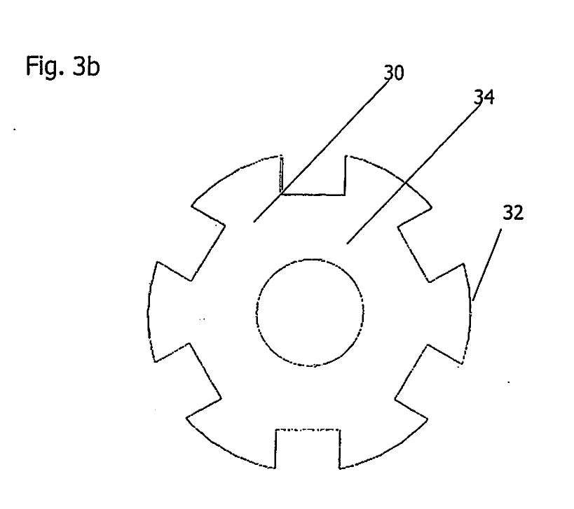

The rotor 14 is constituted by a stack of thin iron-sheet discs 30, applied to which, in the motionless state, are a tensile stress at their outer edge 32 and a shear stress at their inner edge 34. This can be effected in various ways. A variant (see FIG. 3) uses mechanically stress-free, hollow sheet-metal parts having the form, substantially, of a truncated circular cone (see FIG. 3a), which are to be pressed into an at least almost flat form (see FIG. 3b). As a result, the outer edge 32 of the thus resulting sheet-metal discs is subjected to tensile stress and its inner edge 34 is subjected to shear stress.

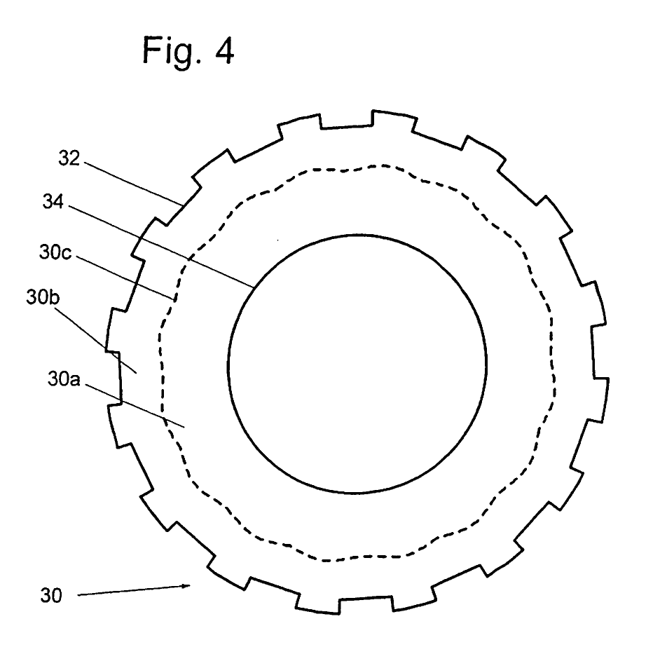

Another possibility for obtaining iron-sheet discs 30 having this characteristic (see FIG. 4) consists in two planar, concentric rings 30a, 30b being welded to one another along a joining line 30c, while the inner ring 30a is under shear stress and the outer ring 30b is under tensile stress. There is thus produced a substantially planar sheet-metal disc 30, which, in the non-rotating state, is subjected to a tensile stress at its outer edge 32 and to a shear stress at its inner edge 34. Since two differing metals may also be used in this case, there is the possibility, in the case of this variant, of selecting a material of greater strength for the inner ring 30a and of using a material having optimal magnetic properties for the outer ring 30b. Moreover, in the case of this variant, the form of the two concentric rings 30a, 30b and their joining line 30c may be so configured that the joining line 30c runs close to or exactly along the neutral layer (where shear stress and tensile stress are equal to zero) of the thus obtained disc 30.

These sheet-metal discs 30, stacked upon one another to constitute the rotating body (rotor 14 and fly-mass 22) and, if necessary, held in their planar form by base and cover plates—not represented in the figure—of the rotating body, can then be brought to a rotational speed that can be higher than would be the case in view of the strength properties of the sheet-metal discs without the tensile/shear stresses applied to them.

In the case of the higher rotational speed, these sheet-metal sheets 30 then, as a result of the centrifugal force acting upon them, are subjected, at their outer edge 32, to a tensile stress that is greater than the first tensile stress, and are subjected, at their inner edge 34, to a shear stress that is less than the first shear stress.

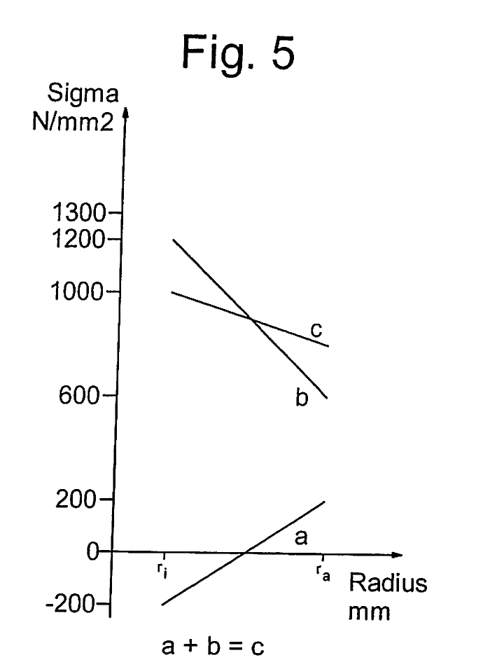

The tensile and shear stresses applied to the sheet-metal discs 30 when in the inoperative state increase from the inner edge 34 towards the outer edge 32 (negative stresses are shear stresses and positive stresses are tensile stresses). Although the stresses caused by the centrifugal force upon the rotation of the sheet-metal disc 30 are in the positive range, they nevertheless decrease from the inside to the outside. This results in a levelled stress profile. Moreover, this stress profile is an amount less than if sheet-metal discs 30 are used that have not had these tensile and shear stresses applied to them in the inoperative state. Consequently, higher rotational speeds are admissible in the case of the sheet-metal discs 30 subjected, in the inoperative state, to tensile and shear stresses. This situation is illustrated in FIG. 5.

The basis in this case is an annular sheet-metal disc 30 whose inner edge 34 has a radius n and whose outer edge 32 has a radius rₐ. The maximum material strength (the yield strength) of the sheet-metal disc 30 is to be assumed to be +1300 N/mm². In the inoperative state, a shear stress of, for example, −200 N/mm², is applied to the inner edge 34 of the sheet-metal disc 30. In the inoperative state, a tensile stress of, for example, +200 N/mm² is applied to the outer edge 32 of the sheet-metal disc 30. There results therefrom, in the inoperative state, approximately a stress progression such as that indicated by the straight line “a”.

If this annular sheet-metal disc 30 is made to rotate about its central axis (R in FIG. 1), the centrifugal force causes a stress progression that decreases, from the inside to the outside, between +1200 N/mm² and +600 N/mm², such as that indicated approximately by the straight line “b”. These two stress progressions “a”, “b”, when superimposed on one another, produce the resulting stress progression “c” having a lesser (negative) gradient than the stress progression “b” (see FIG. 5). The stress progression “c” resulting therefrom has a lesser stress level, of +1000 N/mm², at the inner edge, while the stress level of +800 N/mm² at the outer edge has likewise not yet attained the yield strength of the material of the sheet-metal disc. Thus, the rotational speed can be increased yet further, until the centrifugal force caused in this case exerts upon the sheet-metal disc 30 a stress that comes close to the maximum material strength (yield strength) of the sheet-metal disc 30. This rotational speed, however, is higher than the rotational speed at which a sheet-metal disc 30 not having the stress progression “a” applied comes close to the maximum material strength of the sheet-metal disc 30.

Since the maximum rotational speed of the rotating body determines the upper limit of the energy storage capacity of the energy storage device, this upper limit of the energy storage capacity is increased by the stress progression “a” applied to the sheet-metal disc 30.

The shear stress applied to the sheet-metal disc 30 need not—as in the previous example—correspond by an amount to the tensile stress applied to the sheet-metal disc 30. Rather, it can be varied to model the progression/gradient of the stress progression “a” in order thus to influence the resultant stress progression “c”.

The stator 16 and the rotor 14 are grooved in a pronounced manner on their respective, mutually facing peripheral surfaces. For this purpose, the stator 16 and the rotor 14 each have an even number (differing from one another) of teeth 16a and 14j, respectively. The coils 20 are exclusively in/on the stator 16, and have the form of concentrated windings. Thus, there are pronounced pole teeth 16a in the stator 16.

Differing numbers of teeth can be provided in the stator 16 and rotor 14 in order to even out the by the torque of the switched reluctance machine. A multiplicity of possible combinations of the stator tooth number (ZS) and rotor tooth number (ZL) may be chosen. Here, a combination stator tooth number (ZS)>rotor tooth number (ZL) is preferred.

Upon a rotational motion of the rotor 14, the self-inductance of a stator coil 20 varies periodically between a least value and a greatest value. The torque on the rotor is proportional to the square of the current through the stator coils 20, i.e. direction of the torque is non-dependent on the direction of the current in the stator coils 20. The sign of the torque is dependent on the sign of the inductance change upon rotation of the rotor 14. A positive torque (motor operating mode) is produced in the case of an increasing inductance, a negative torque (generator operating mode) being produced in the case of a decreasing inductance. A large change in the inductance as a function of the rotor position effects a large torque.

The switched reluctance machine is suitable for highly effective energy conversion in a wide rotational-speed range. The rotor 14 can be produced cost-effectively in relatively few production steps. The stator 16 can have pronounced poles 16a, on which concentrated stator coils 20 can be arranged. The stator coils 20 can either be slipped on, as preformed coils, or produced in a direct winding operation. The heat loss produced in the stator 16 is easily dissipated.

This electrical machine has have a very simply constructed, robustly realized rotor, which can also be so designed that it produces little magnetic loss. Very high rotational speeds (up to 200,000 rpm and more) can be realized by means of such a machine. A further aspect is the electrical/magnetic de-excitation capability of the switched reluctance machine. This is important for the energy storage capability in the case of small (for example, magnetic) losses.

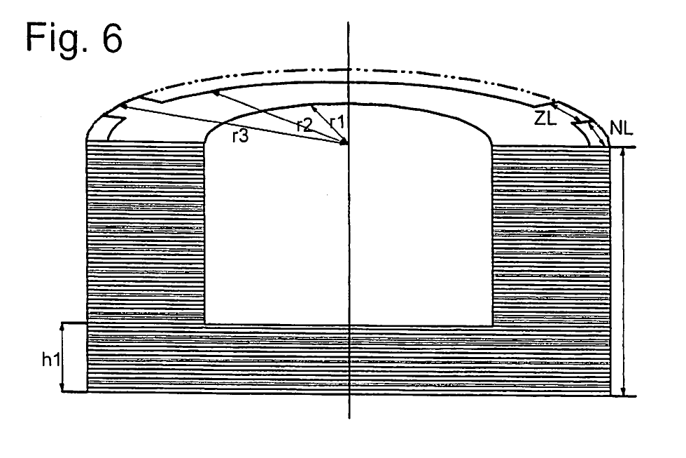

The kinetic energy Eₖᵢₙ to be stored in the rotor 14 and in the assigned fly-mass (see FIG. 6) is to be determined approximately according to the following relationship:

Eₖᵢₙ=¼·ω²·ç·n·[h₁·r₁⁴+h₂·(r₂⁴−r₁⁴)+½·h₂(r₃⁴−r₂⁴)]

wherein

ω is the angular velocity of the rotor 14 in s⁻¹

ç is the density of the material (for example, iron) of the rotor 14

n is the constant pi (3,14 . . . )

h₁ is the height of the base part 14a of the rotor 14 in m

h₂ is the height of the annular-cylindrical wall part 14b of the rotor 14 in m

rᵢ is the inner radius of the wall part 14b of the rotor in m

r₂ is the outer radius of the wall part 14b of the rotor in m

r₃ is the outer radius of the teeth 14j of the rotor in m

In this case, the circumferential length ZL of the teeth 14j of the rotor 14 is equal to the groove length NL of the groove between two adjacent teeth 14j (see FIG. 6).

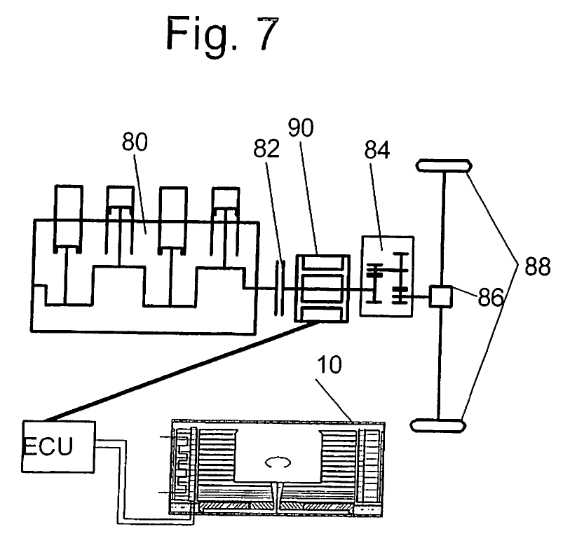

When the energy storage device is in the motor operating mode or the charging operating mode (see FIG. 7), the stator coils 20 of the energy storage device—controlled by an electronic power control unit ECU—are supplied with electric current, which comes from an electrical machine 90 present in the drive train of the motor vehicle (internal combustion engine 80, clutch 82, transmission 84, differential 86, wheels 88). This electrical machine 90 is consequently in the generator operating mode and brakes the motor vehicle. As a result, the rotor 14 and, with it, the fly-mass 22 of the energy storage device, is put into rotation.

When the energy storage device is in the generator operating mode or the discharging operating mode (see FIG. 7), its rotor 14 is put into rotation by the fly-mass 22, at a high rotational speed. The stator coils 20 of the energy storage device then supply electrical energy. This electrical energy—controlled by the electronic power control unit ECU—is fed into the electrical machine 90 present in the drive train of the motor vehicle. This electrical machine 90 is consequently in the motor operating mode, and drives the motor vehicle.

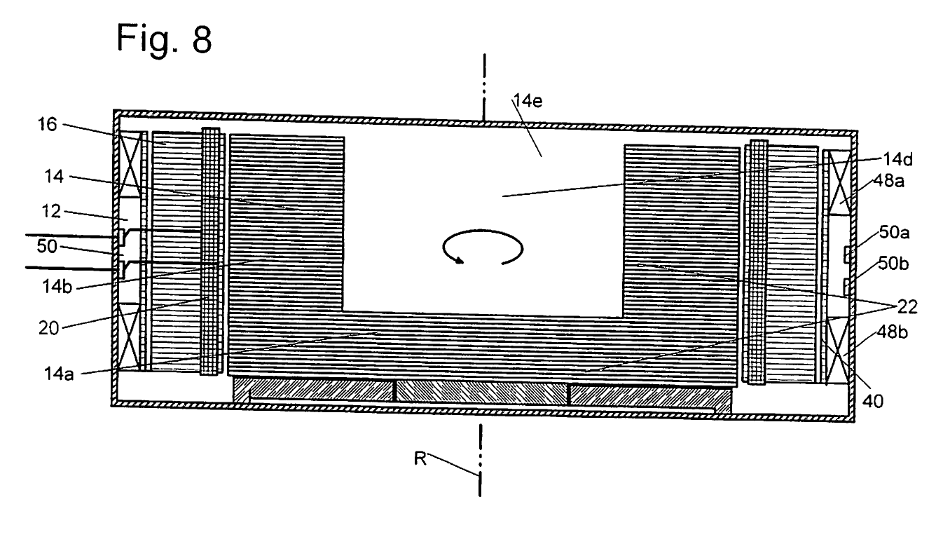

Another embodiment of the energy storage device is illustrated in FIG. 8, components that are comparable to or perform the same function as those in FIG. 1 being denoted by the same references, and not being explained again in the following. An essential difference relative to the embodiment according to FIG. 6 consists in that the stator 16 is arranged, likewise so as to be rotatable about the rotational axis R, in relation to the housing 10 by means of two rolling-contact bearings 48a, 48b. In this case, current is supplied to the stator coil(s) 20 by means of a slipring arrangement 50, which is arranged on the wall of the housing 10 and electrically contacts the stator coil(s) 20. For reasons of clarity, only two contact-sliprings 50a, 50b are shown; the number of sliprings depends on the number of stator coils 20. In this case, the mechanical contact can be designed to be disengageable (for example, electromagnetically), such that the frictional losses are reduced when no electrical power is being transferred via the slipring arrangement 50. In the case of this arrangement, the rotor and the “stator” rotate in mutually opposing directions when current is supplied to the stator coil(s) 20. In this way, it is possible to provide an arrangement of the energy storage device that is very efficient in respect of structural space. Instead of the slipring arrangement 50, it is also possible for the electrical power to be inductively or capacitively coupled into the stator coil(s) 20 or coupled out of the latter.

It has been assumed in the above that the rotating body is both a fly-mass and a rotor of the electric motor, and thus has a double function. It is also possible, however, for there to be designed for a fly storage device, in the manner described, a rotating body that takes up, stores and delivers energy by means of another electrical machine (and, if necessary, a transmission).

For this purpose, a fly-body is constituted by thin sheet-metallic discs, which have the form, substantially, of an annular disc having an outer edge and an inner edge, and which, in the motionless state, are subject to a first tensile stress at their outer edge and to a first shear stress at their inner edge.

In the rotating state, the sheet-metal discs are subjected, at their outer edge, to a tensile stress that is greater than the first tensile stress, and are subjected, at their inner edge, to a shear stress that is less than the first shear stress.

These planar sheet-metal discs are constituted in that sheet-metal parts, having the form of a curved surface of a truncated circular cone and being mechanically substantially stress-free, are pressed into a substantially flat form, as a result of which the outer edge of the sheet-metal discs is subjected to tensile stress and the inner edge of the sheet-metal discs is subjected to shear stress.

These planar sheet-metal discs can also be constituted in that two planar concentric rings, being an inner and an outer ring, are joined to one another, the inner ring being under shear stress and the outer ring being under tensile stress, as a result of which the sheet-metal disc, in the non-rotating state, is subjected to a tensile stress at its outer edge and to a shear stress at its inner edge.

The inner ring and the outer ring in this case can be constituted by differing materials, it being the case, preferably, that the inner ring has a greater strength and the outer ring is to be optimized in respect of its magnetic properties.

1. Energy storage device, comprising:
an electrical machine including:
a rotor; and
a stator, the stator being separated from the rotor by an air gap and having at least one stator coil, and the rotor being surrounded by the stator, assigned to a fly-mass and constituted by thin sheet-metallic discs, which have a form, substantially, of an annular disc having an outer edge and an inner edge, the sheet-metal discs being configured such that sheet-metal parts, having a form of a curved surface of a truncated circular cone and being mechanically substantially stress-free, are pressed into a substantially disc-shaped form, such that an outer edge of the sheet-metal discs is subjected to tensile stress and the inner edge of the sheet-metal discs is subjected to shear stress.

2. Energy storage device according to claim 1, wherein the sheet-metal discs, when in the rotating state, are subjected, at their outer edge, to a tensile stress that is greater than the applied tensile stress, and, at their inner edge, to a shear stress that is less than the applied shear stress.

3. Energy storage device according to claim 2, wherein the inner ring and the outer ring are constituted by differing materials, such that the inner ring has a greater strength and the outer ring is to be optimized in respect of its magnetic properties.

4. Energy storage device according to claim 1, wherein the device includes a housing having a pressure of less than about 1 bar.

5. Energy storage device according to claim 1, wherein the rotor has a substantially pot-shaped form, having a base part and a substantially annular-cylindrical wall part.

6. Energy storage device according to claim 1, wherein the electrical machine is a switched reluctance machine, and wherein the rotor and stator are grooved.

7. Energy storage device according to claim 1, wherein the rotor is constituted by metal sheets containing iron-carbon.

8. Energy storage device according to claim 4, wherein the rotor is rotatably supported against the housing by a sliding, rolling-contact or fluid bearing means.

9. Energy storage device according to claim 4, wherein the stator is rotatably mounted relative to the housing and relative to the rotor.

10. Energy storage device according to claim 1, wherein the stator is constituted by thin sheet-metal discs, which, in the motionless state, are subject to a first tensile stress at their outer edge and to a first shear stress at their inner edge.

11. Energy storage device according to claim 1, wherein the at least one stator coil is electrically contacted via a slipring arrangement.

12. Motor vehicle, comprising:
a drive train;
at least one electrical machine operatively associated with the drive train, the electrical machine being configured such that it can be switched over between a motor operating mode and a generator operating mode by an electronic power control unit;
an energy storage device operatively associated with the electrical machine, further including a rotor and a stator, the stator being separated from the rotor by an air gap and having at least one stator coil, and the rotor being surrounded by the stator, assigned to a fly-mass and constituted by thin sheet-metallic discs, which have a form, substantially, of an annular disc having an outer edge and an inner edge, and have an inner and an outer planar, concentric ring, which are joined to one another, while the inner ring is under shear stress and the outer ring is under tensile stress, such that the sheet-metal disc, in a non-rotating state, is subjected to a tensile stress at its outer edge and to a shear stress at its inner edge.

13. Use of an energy storage device according to claim 1 in a motor vehicle including a drive train with at least one electrical machine in the drive train, the electrical machine being such that it can be switched over between a motor operating mode and a generator operating mode.

14. Fly-body, comprising: thin sheet-metallic discs, which have a form, substantially, of an annular disc having an outer edge and an inner edge, and which, in the a motionless state, are subject to a first tensile stress at their outer edge and to a first shear stress at their inner edge, the sheet-metal discs being constituted in that sheet-metal parts, having a form of a curved surface of a truncated circular cone and being mechanically substantially stress-free, are pressed into a substantially disc-shaped form, such that the outer edge of the sheet-metal discs is subjected to tensile stress and the inner edge of the sheet-metal discs is subjected to shear stress.

15. Fly-body according to claim 14, wherein, in a rotating state, the sheet-metal discs are subjected, at their outer edge, to a tensile stress that is greater than the first tensile stress, and are subjected, at their inner edge, to a shear stress that is less than the first shear stress.

16. Energy storage device according to claim 1, wherein the sheet-metal discs include an inner and an outer disc-shaped, concentric ring joined to one another, and wherein the inner ring is under shear stress and the outer ring is under tensile stress, the sheet-metal disc, in a non-rotating state, is subjected to a tensile stress at its outer edge and to a shear stress at its inner edge.

17. The motor vehicle according to claim 12, wherein the sheet-metal discs being constituted in that sheet-metal parts, having a form of a curved surface of a truncated circular cone and being mechanically substantially stress-free, are pressed into a substantially disc-shaped form, such that the outer edge of the sheet-metal discs is subjected to tensile stress and the inner edge of the sheet-metal discs is subjected to shear stress.

18. Flybody according to claim 14, wherein the sheet metal discs include an inner disc-shaped concentric ring and an outer disc-shaped concentric ring joined to one another, the inner ring being under shear stress and the outer ring being under tensile stress, such that the sheet-metal disc, in a non-rotating state, is subjected to a tensile stress at its outer edge and to a shear stress at its inner edge.
